(19) United States
(12) Patent Application Publication
(10) Pub. No.: US 2021/0259257 A1
(43) Pub. Date: Aug. 26, 2021

(54) SOFT MATERIAL FORMING APPARATUS

(71) Applicant: ANKO FOOD MACHINE CO., LTD., New Taipei City (TW)

(72) Inventors: LI-HSIEN WANG, New Taipei City (TW); CHIEN YUAN, New Taipei City (TW); YOU-CHEN TSAI, New Taipei City (TW)

(21) Appl. No.: 16/878,602

(22) Filed: May 19, 2020

(30) Foreign Application Priority Data
Feb. 21, 2020 (TW) 109201941

(51) Int. Cl. A21C 3/04; A21C 9/06; A21C 3/10

(52) U.S. Cl. CPC A21C 3/04; A21C 3/10; A21C 9/061

(57) ABSTRACT

The present invention provides a soft material forming apparatus, which comprises a forming mold assembly and a detaching assembly. The forming mold assembly comprises a first roller and a second roller, for extruding a product. There is a specific interval between the detaching assembly and the first roller. The product comprises a release portion which is the earliest part of the product that contacts the detaching assembly. With the specific interval and the rotatability of the detaching assembly, the product can be released from the forming mold assembly.

### FIELD OF THE INVENTION

The present invention relates to a soft material forming apparatus, and in particular, is related to an apparatus applied in a field of food processing machinery, for solving the detaching issue after extrusion molding

### BACKGROUND OF THE INVENTION

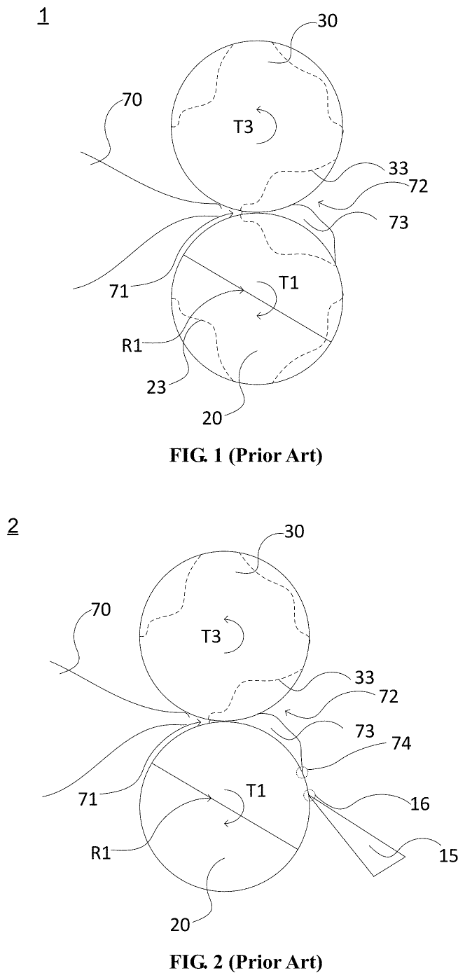

With reference to FIG. 1, a first conventional soft material forming apparatus 1. Conventionally, a soft material 70 is inputted from a feeding side 71 of a mold assembly (a first roller 20 with multiple forming molds 23 and a second roller 30 with multiple forming molds 33), and a product 73 is formed by using the rotation, extrusion and formation of the rollers 20, 30. Generally, the product 73 will be attached on one of the rollers 20, 30, once the product 73 does not be separated from the rollers 20, 30 on an output side 72, the product 73 will squeeze the soft material 70 which is inputted again when the product 73 is rotated along the rollers 20, 30 to the feeding side 71, then the apparatus will be malfunction. The arrows inside the rollers 20, 30 indicate rotating directions of the rollers 20, 30.

With reference to FIG. 2, a second conventional soft material forming apparatus 2. This conventional art uses a scraper to detach the product. Meanwhile, one limitation is that a scraper 15 needs to be fixed at an output side 72 of the mold assembly (a first roller 20 and a second roller 30 with multiple forming molds 33), and a tip 16 of the scraper (where is a portion of the scraper 15 nearest to the roller 20) is aimed to a maximum outer diameter R1 of the roller 20. Hence, the first roller 20 could not have forming molds 33 like the second roller 30. If there are forming molds 23 on the first roller as FIG. 1, the scraper 15 will cut the product 73 into half along the maximum outer diameter R1 of the first roller 20. The main disadvantage of using the scraper is that the first roller 20 does not have folding mold 23 (refer to FIGS. 1-2), so one side of the product 73 will be planer with poor appearance. For example, when the product 73 is a dumpling (with external dough and internal fillings), one side is planer will affect the user's food experience for its poor appearance.

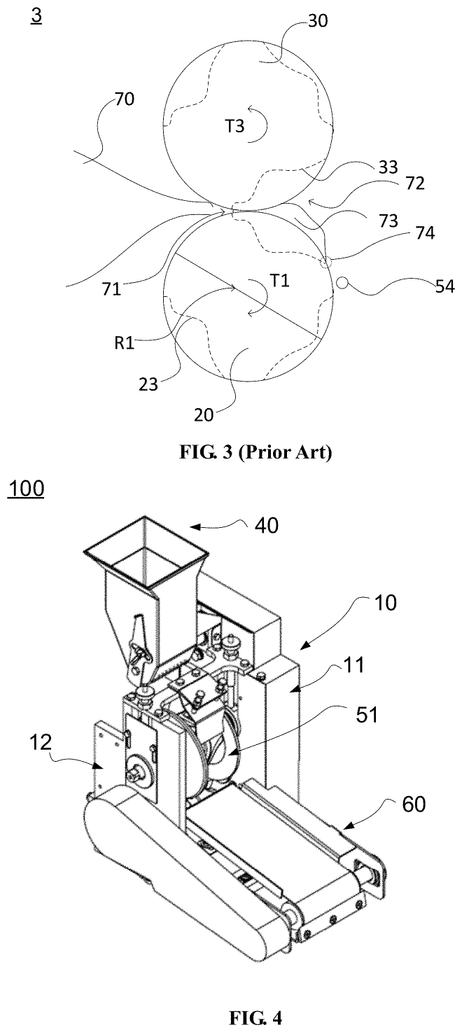

Further referring to FIG. 3, a third conventional soft material forming apparatus 3, a utility model invention TW M580877 U previously announced by the Taiwan Intellectual Property Office (TIPO). Compared with the previously conventional art, it is able to apply a first roller 20 with multiple forming molds 23 and a second roller 30 with multiple forming molds 33. This conventional art uses an ejection claw 54 to hook a release portion 74 of a product 73 (a position where the product 73 first contacts the ejection claw 54) which is attached on the first roller 20 after the shape is formed, and then the whole product 73 will be detached. However, the technical issues such as assembling difficulty and rising cost with the design of adding the ejection claw.

It should be noted that FIGS. 1-3 only show the drawing roller (including the forming mold or not including the forming mold), and the remaining components (such as a fixing structure, a feeding device, and the dusting device) can refer to the utility model invention (TW M580877 U) announced by the TIPO.

Hence, it is needed to provide a soft material forming apparatus, for solving the aforementioned technical problem.

### SUMMARY OF THE INVENTION

In order to solve the aforementioned technical problems of the conventional art, the object of the present invention is to provide a soft material forming apparatus which comprises a forming mold assembly and a detaching assembly. The forming mold assembly comprises a first roller and a second mold. The forming mold assembly comprises at least one forming mold which is used to undertake a soft material from a feeding side of the forming mold assembly and form a product by the forming mold. The product comprises a release portion, and the product is separated from the forming mold assembly at an export side of the forming mold assembly. A specific interval is between the detaching assembly and the first roller and the release portion is a portion of the product first contact the detaching assembly. The specific interval is smaller than or equal to a thickness of the release portion excessing from a maximum outer diameter of the first roller and the release portion will be detached from the first roller when contacting the detaching assembly.

In one preferred embodiment, the specific interval is between 0 mm to 0.5 mm

In one preferred embodiment, the detaching mold assembly comprises at least one roller and/or at least one transport belt.

In one preferred embodiment, a tangential speed of the detaching mold assembly at a point of contact with the release portion is opposite to a tangential speed of the first roller.

In one preferred embodiment, the second mold comprises at least one roller and/or at least one plane board.

In one preferred embodiment, a tangential speed of the release portion is less or equal to a tangential speed of the detaching mold assembly at a point of contact with the release portion.

Compared with the conventional arts, the present invention makes the product successively separate from the first roller for a reason that the portion of the detaching assembly first contact with the product is rotatable and the specific interval between the detaching assembly and the first roller.

### DESCRIPTION OF THE DIAGRAMS

FIG. 1 is an illustrative diagram of a first conventional soft material forming apparatus;

FIG. 2 is an illustrative diagram of a second conventional soft material forming apparatus;

FIG. 3 is an illustrative diagram of a third conventional soft material forming apparatus;

FIG. 4 is an illustrative diagram of a first embodiment of a soft material forming apparatus according to the present application;

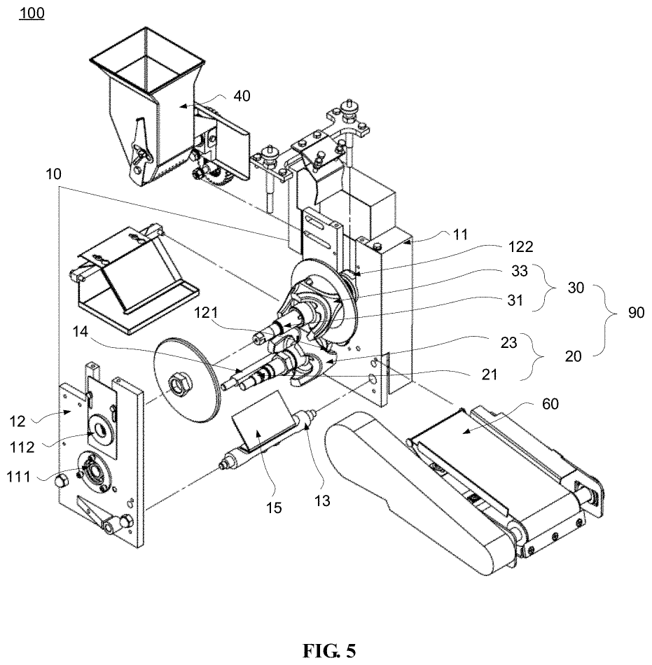

FIG. 5 is an explosive diagram of a first embodiment of a soft material forming apparatus according to the present application;

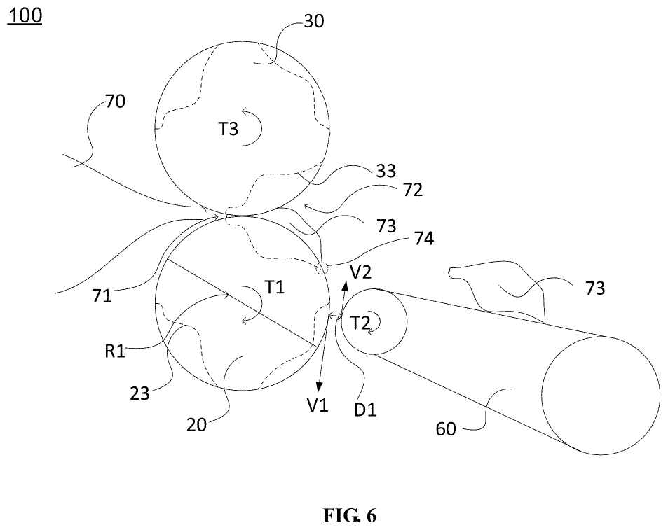

FIG. 6 is an enlarge diagram of the first roller, the second roller and the detaching assembly of FIG. 5;

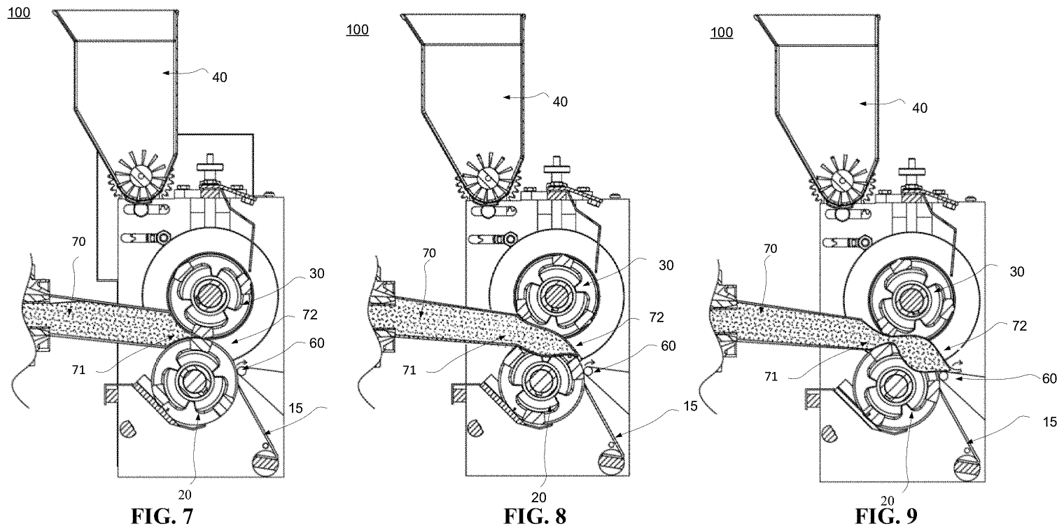

FIGS. 7-9 are continuous action diagrams of the present application.

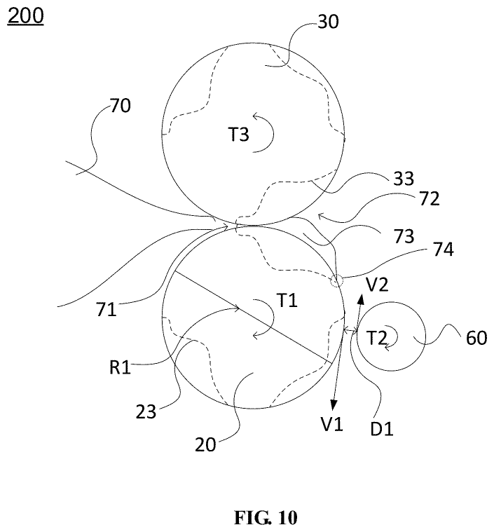

FIG. 10 is an illustrative diagram of a second embodiment of a soft material forming apparatus according to the present application;

### DETAILED DESCRIPTION OF THE PREFERRED EMBODIMENTS

The following description of the embodiments is given by way of illustration with reference to the specific embodiments in which the invention may be practiced. The terms such as “up”, “down”, “front”, “back”, “left”, “right”, “inside”, “outside”, “side”, etc., The direction of the diagram. Accordingly, the use of a directional term is used to describe and to understand the present invention and is not intended to limit the invention.

Please refer to FIGS. 4-6, a soft material forming apparatus 100 of the present invention includes at least a fixed structure 10 having two side plates 11, 12 opposite to each other, which are connected by a plurality of support rod assemblies 13, 14 on two opposite shaft holes 111, 121 and long shaft holes 112, 122 on the two side plates 11, 12 which are respectively provided, and a soft material 70 is input from a feeding side 71. The soft material 70 may be a single material (such as a filling) or a plurality of materials (dough and a filling).

In addition to the basic structural components described above, the soft material forming apparatus 100 further comprises a forming mold assembly 90, a detaching assembly 60, and a powder spraying device 40. The forming mold assembly 90 comprises a first roller 20 and a second roller 30. The powder spraying device 40 is used for timely spraying out dry powder to make the product 73 easy to form. However, the powder spraying device 40 is an additional device and is not a feature of this application.

The first roller 20 has a transmission shaft 21 penetrating the forming mold 23, and a gear set (not shown) is provided at the end of the transmission shaft 21. The first roller 20 is positioned between the shaft holes 111, 121 of the two side plates 11, 12 by the transmission shaft 21, which allows the forming molds 23 to be erected between the two side plates 11, 12. Furthermore, the first roller 20 rotates in a first rotation direction T1 to receive a soft material 70 from a feeding side 71 of the forming mold assembly 90 and the product 73 is formed by the at least one forming mold 23.

The second roller 30 has a transmission shaft 31 penetrating the forming mold 33, and a gear set (not shown) is provided at the end of the transmission shaft 31. The first roller 30 is positioned between the shaft holes 112, 122 of the two side plates 11, 12 by the transmission shaft 31, which allows the forming molds 33 to be erected between the two side plates 11, 12. The forming molds 22, 33 of the first roller 20 and the second roller 30 are relatively engaged with each other, and a gear set (not shown) is connected to the power mechanism to rotate synchronously. In addition, the first roller 20 and the second roller 30 are positioned up and down correspondingly. It is noted that the second roller 30 rotates at a third direction T3. Preferably, the first roller 20 and the second roller 30 are rotate at a constant speed.

In the preferred embodiment, the detaching assembly 60 is a transmission track. Referring to FIG. 6, a specific interval D1 exists between the detaching assembly 60 and the first roller 20. The product 73 includes a release portion 74, and the release portion 74 is the earliest part of the product 73 contacting the detaching assembly 60. The product 73 is separated from the forming mold assembly 90 by an export side 72 of the forming mold assembly 90. The specific interval D1 is smaller than or equal to a thickness of the release portion 74 excessing from a maximum outer diameter R1 of the first roller 20. When the release portion 74 contacts the detaching assembly 60, the release portion 74 might be deformed to detach from the first roller 20 or to be detached from the first roller 20 due to friction. In the present preferred embodiment, the detaching component 60 is composed of two rotating rollers and a track (generally driven by a motor). Therefore, the roller of the detaching assembly 60 closest to the first roller 20 rotates in a second rotation direction T2, so as to separate the product 73 from the first roller 20.

In detail, a position of the detaching assembly 60 first contacts the product 73 has a second tangential speed V2 which is larger than or equal to a first tangential speed V1 of the release portion 74. Preferably, the first tangential speed V1 and the second tangential speed V2 are opposite.

Preferably, in the preferred embodiment, the detaching assembly 60 is driven (automatically rotated) by using an electric component such as a motor. However, the detaching assembly 60 is not necessarily required to use electric power. Only the rotation can be caused by the reaction force generated when contacting the release portion 74 (passive rotation).

In the preferred embodiment, the second mold is the second roller 30 with the forming molds 33. However, in different application situation, the second mold might be a second roller 30 without the forming mold 33 or a plate (fixed or movable), only if the detaching assembly 60 can generate the second tangential speed V2 at the position of the detaching assembly 60 closest to the release portion 74 and an enough space for separating the product 73 from the first roller 20.

In addition, a scraper 15 is provided. The scraper 15 can scrape off the soft material 70 remaining in the first roller 20 after the product 73 is detached from the first roller 20 to ensure the soft material forming apparatus 100 is functioning normally.

With referring to FIGS. 7-9, the continuous action diagrams of the application. For the components, please refer to FIGS. 4-6, which will not be described in detail. First, in FIG. 7, the soft material 70 is input between the first roller 20 and the second roller 30 from the feeding side 71; then, in FIG. 8, the soft material 70 passes through the forming molds 23, 33 and be extruded to form a semi-finished product (the front half has been formed, and the rear half has not been formed); then, in FIG. 9, the release portion 74 of the product 73 has contacted the detaching assembly 60 and a part of the product 73 has been released from the first roller 20; finally, the rear half of the product 73 will be extruded by the forming molds 23, 33, and then taken to the detaching assembly 60 together with the front half of the product 73 that has been detached from the first roller 20.

FIG. 10 is an illustrative diagram of a second soft material forming apparatus 200 according to the present application. For the components, please refer to FIGS. 4-6, which will not be described in detail. The difference between this preferred embodiment and the first preferred embodiment is that the detaching assembly 60 of this preferred embodiment is a roller. The function of the detaching assembly 60 is to use the specific interval D1 and the portion of the detaching assembly first contacts the release portion 74 is movable (either rotating or moving). When the product 73 is separated from the first roller 20, a conveying device is provided below or behind the roller of the embodiment, and it is not limited that a conveyor belt like the first preferred embodiment must be used.

It should be noted that FIGS. 6, 10 only show the rollers 20, 30 (including or not including the mold) and the detaching assembly 60, and the remaining components (such as the fixed structure, the feeding device, and the powder spraying device) Etc.) Please refer to FIG. 5 or the utility model invention (TW M580877 U) announced by the TIPO.

As described above, although the present application comprises been described with the preferred embodiments thereof, those skilled in the art will appreciate that various modifications, additions, and substitutions are possible without departing from the scope and the spirit of the application. Accordingly, the scope of the present application is intended to be defined only by reference to the claims.

What is claimed is:

1. A soft material forming apparatus, comprising:
a forming mold assembly, comprising a first roller and a second mold, the forming mold assembly comprising at least one forming mold which being used to undertake a soft material from a feeding side of the forming mold assembly and form a product by the forming mold, the product comprising a release portion, the product separating from the forming mold assembly at an export side of the forming mold assembly;
a detaching assembly, a specific interval being between the detaching assembly and the first roller, the release portion being a portion of the product first contact the detaching assembly;
wherein the specific interval is smaller than or equal to a thickness of the release portion excessing from a maximum outer diameter of the first roller, the release portion is detached from the first roller when contacting the detaching assembly.

2. The soft material forming apparatus according to claim 1, wherein the specific interval is between 0 mm to 0.5 mm.

3. The soft material forming apparatus according to claim 1, wherein the detaching mold assembly comprises at least one roller and/or at least one transport belt.

4. The soft material forming apparatus according to claim 1, wherein a tangential speed of the detaching mold assembly at a point of contact with the release portion is opposite to a tangential speed of the first roller.

5. The soft material forming apparatus according to claim 1, wherein the second mold comprises at least one roller and/or at least one plane board.

6. The soft material forming apparatus according to claim 1, wherein a tangential speed of the release portion is less or equal to a tangential speed of the detaching mold assembly at a point of contact with the release portion.
